(19) United States
(12) Patent Application Publication
(10) Pub. No.: US 2025/0211287 A1
(43) Pub. Date: Jun. 26, 2025

(54) RECONFIGURABLE INTELLIGENT SURFACE REFERENCE SIGNALS

(71) Applicant: QUALCOMM Incorporated, San Diego, CA (US)

(72) Inventors: Zhikun WU, Beijing (CN); Yu ZHANG, San Diego, CA (US); Hung Dinh LY, San Diego, CA (US); Alexandros MANOLAKOS, Athens (GR)

(21) Appl. No.: 18/852,154

(22) PCT Filed: May 11, 2023
(86) PCT No.: PCT/CN2023/093416

§ 371 Date: Sep. 27, 2024

(30) Foreign Application Priority Data
May 26, 2022 (WO) PCT/CN2022/095138

(51) Int. Cl. H04B 7/04; H04L 5/00; H04W 24/10; H04W 74/0833

(52) U.S. Cl. CPC H04B 7/04013; H04L 5/0048; H04W 24/10; H04W 74/0833

(57) ABSTRACT

Certain aspects of the present disclosure provide techniques for wireless communications. In one example, a method includes transmitting, to a reconfigurable intelligent surface (RIS), a reconfigurable intelligent surface reference signal (RIS-RS) configured for a user equipment, wherein the RIS-RS is not associated with a physical broadcast channel (PBCH); and receiving, from the user equipment, a channel state information (CSI) report comprising one or more measurements associated with the RIS-RS.

### CROSS-REFERENCE TO RELATED APPLICATION & PRIORITY CLAIM

This application claims benefit of and priority to Patent Cooperation Treaty Application No. PCT/CN2022/095138, filed May 26, 2022, which is herein incorporated by reference in its entirety for all applicable purposes.

### BACKGROUND

### Field of the Disclosure

Aspects of the present disclosure relate to wireless communications, and more particularly, to techniques for utilizing reconfigurable intelligent surfaces.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method of wireless communications by a network entity. The method includes transmitting, to a reconfigurable intelligent surface (RIS), a RIS reference signal (RIS-RS) configured for a user equipment (UE), the RIS-RS is not associated with a physical broadcast channel (PBCH). The method includes receiving, from the UE, a channel state information (CSI) report comprising one or more measurements associated with the RIS-RS.

Another aspect provides a method of wireless communications by a user equipment. The method includes receiving, from a reconfigurable intelligent surface, a RIS-RS transmitted by a network entity, the RIS-RS is not associated with a PBCH. The method includes transmitting, to the network entity, a CSI report comprising one or more measurements associated with the RIS-RS.

Other aspects provide: an apparatus operable, configured, or otherwise adapted to perform the aforementioned methods and/or those described elsewhere herein; a non-transitory, computer-readable media comprising instructions that, when executed by a processor of an apparatus, cause the apparatus to perform the aforementioned methods and/or those described elsewhere herein; a computer program product embodied on a computer-readable storage medium comprising code for performing the aforementioned methods and/or those described elsewhere herein; and an apparatus comprising means for performing the aforementioned methods and/or those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5 depicts an example of a beam sweeping procedure between a network entity and a user equipment.

FIG. 6 depicts an example of a beam sweeping procedure between a network entity, a reconfigurable intelligent surface, and a user equipment.

FIG. 7 depicts another example of a beam sweeping procedure between a network entity, a reconfigurable intelligent surface, and a user equipment.

FIG. 8A depicts an example of a beam sweeping procedure between a network entity, a reflective intelligent surface, and a user equipment using novel reconfigurable intelligent surface reference signals.

FIG. 8B depicts an example scenario in which a beam failure occurs between a RIS and a user equipment.

FIG. 9A depicts an example of a data structure for a conventional synchronization signal block.

FIG. 9B depicts an example of a data structure for a reconfigurable intelligent surface reference signal.

FIG. 10A depicts an example of concurrent scheduling of sets of SSBs and reconfigurable intelligent surface reference signals.

FIG. 10B depicts an example of sharing resource ranges for defining reconfigurable intelligent surface reference signals and other reference signal sets.

FIG. 11 depicts a process flow for performing beam management in a communications network between a network entity, a reconfigurable intelligent surface, and a user equipment.

FIG. 12 depicts a method for wireless communications by a network entity.

FIG. 13 depicts a method for wireless communications by a user equipment.

FIG. 14 depicts aspects of an example communications device.

FIG. 15 depicts aspects of another example communications device.

### DETAILED DESCRIPTION

Aspects of the present disclosure provide apparatuses, methods, processing systems, and computer-readable mediums for utilizing reconfigurable intelligent surface reference signals for beam management.

Advanced wireless communications systems use many different techniques to improve system performance. Beam management is one such technique, which generally includes the determination of optimal transmitting and receiving beams, for example, between a network entity and a user equipment. Beam management may include many related techniques, including beam sweeping, beam measurements, beam determination, beam reporting, and beam failure recovery.

Generally, beam management is performed using various types of reference signals, such as synchronization signal blocks, channel state information reference signals, and others. Various reference signals may be referred to as “beams” in the context of beam management.

Beam sweeping generally involves transmitting a plurality of reference beams (e.g., in a burst) in different directions at a regular interval. For example, different synchronization signal blocks (SSBs) may be transmitted carrying primary synchronization signals, secondary synchronization signals, and a physical broadcast channel. A user equipment receiving one or more of the SSBs as reference beams may then measure the reference beams, determine one or more best reference beams, and report the best reference beams back to the network entity so that subsequent communications may be performed using the best beams. Further refinement may be performed using other reference signals, such as channel state information reference signals (CSI-RS). In some aspects, a CSI-RS may be considered a relatively narrower beam and an SSB may be considered a relatively wider beam.

Because network entities, such as base stations, are finite in number and have static and dynamic environmental factors to contend with while trying to provide broad coverage to user equipments, it is desirable to introduce new elements into a communications system that can improve wireless communications performance more efficiently (e.g., in terms of power, space, cost, and the like) than simply multiplying the number of base stations in a given area-especially in challenging areas for wireless communications, like dense urban environments. Reconfigurable intelligent surfaces (RISs) are one such new element that can improve wireless communications performance.

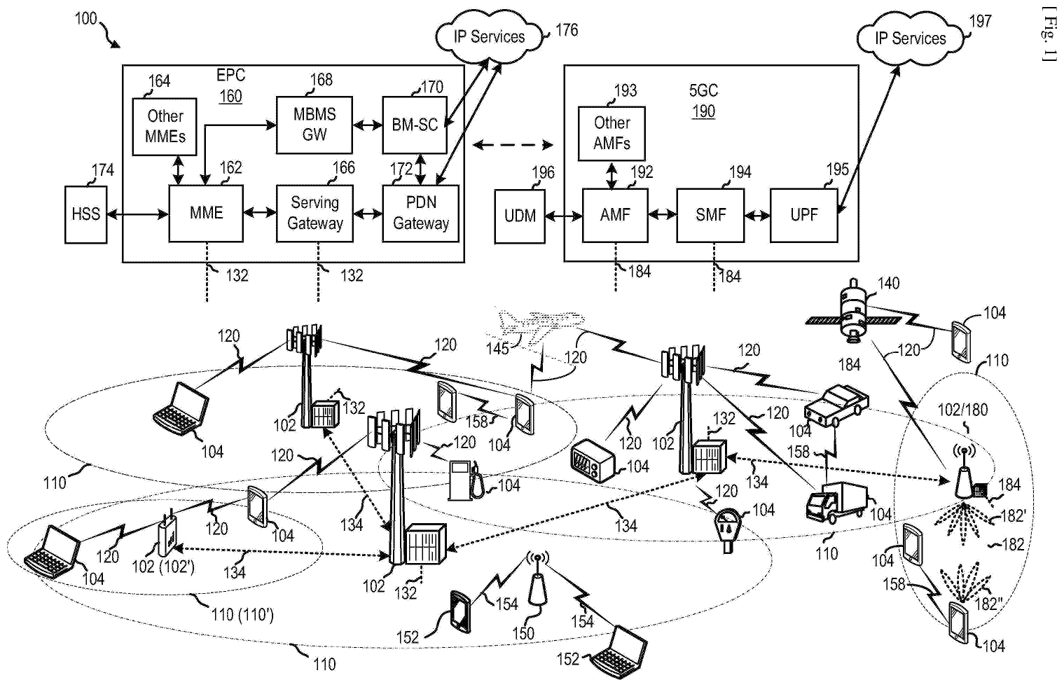

A RIS is a device that can change characteristics of an impinging electromagnetic wave, such as the phase, polarization, amplitude, or other characteristics of the wave. A RIS may be a reflective device, a refractive (or transmissive) device, or a simultaneously reflective and refractive device. For example, a RIS may be a 2-D antenna array comprising many individual scattering elements. The scattering elements are a type of configurable metasurface that can control the phase shifts of individual scattering elements. Thus, an RIS can be utilized to manipulate (e.g., beamform) radio waves that impinge on the “intelligent” surface, helping to improve the penetration and coverage of wireless communications systems, such as the example described below with respect to FIG. 1. Beneficially, because an RIS may be physically smaller, easier to place, more power efficient, less complex, and less costly compared to a base station, RISs may be employed in large numbers to improve communications system performance.

However, an issue arises when utilizing RISs in a communications system that also utilizes advanced techniques, such as beamforming, which is that reference signals that are reflected and/or refracted by an RIS are no longer quasi-collocated with the, for example, the network entity transmitting the reference signals. Generally, two transmitting antenna ports are said to be quasi-collocated if properties of the channel over which a symbol on one antenna port is conveyed can be inferred from the channel over which a symbol on the other antenna port is conveyed. In other words, because the symbols emanate from very similar locations, and are received at very similar locations, the channel conditions between the two locations may be assumed to be very similar. The quasi-collocation assumption benefits a device receiving the reference symbols because the device is able to make assumptions about the channel conditions for one symbol based on measured channel conditions for another symbol, if there is a quasi-collocation relationship between the symbols. Such channel conditions include, for example, Doppler shift, Doppler spread, average delay, and delay spread.

However, when, for example, a first symbol from a first antenna port is transmitted directly from a network entity to a user equipment, and a second symbol is transmitted indirectly from the network entity to the user equipment via a RIS, the channel conditions of the two symbols cannot be inferred from each other, and the quasi-collocation assumption is undone. Without the quasi-collocation assumption, many types of reference signals that rely on the quasi-collocation assumption no longer function correctly for a device, such as a user equipment, receiving reference signals directly, and indirectly, such as by way of an RIS.

Thus, conventional reference signals (e.g., those defined in standards, such as 3GPP), present a technical problem for performing beam sweeping when employing RISs in a wireless communication system. Specifically, the following Table 1 demonstrates various aspects of conventional reference signals.

TABLE 1
Reference Signals

| | Reference signals | | | | |
|---|---|---|---|---|---|
| | | | Work as | L1 | |
| | Index | Need QCL | QCL | measurement | Work as |
| | range | source | source | report | RLM RS |
| CSI-RS | 196 (✓) | Yes (x) | Yes (✓) | Yes (✓) | Yes (✓) |
| for CSI | | | | | |
| CSI-RS | 196 (✓) | Yes (x) | Yes (✓) | No (x) | Yes (✓) |
| for tracking | | | | | |
| CSI-SSB | 64 (x) | No (✓) | Yes (✓) | Yes (✓) | Yes (✓) |
| CSI-RS | 96 (x) | Yes (✓) | No (x) | No (x) | No (x) |
| for RRM | | | | | |

In Table 1, “Work as QCL source” means the particular reference signal can be indicated in a transmission configuration indicator (TCI); RLM stands for radio link monitoring; QCL stands for quasi-collocation; ‘√’ means that the particular feature is suitable for RIS beam sweeping; and ‘x’ means that the particular feature is not suitable for RIS beam sweeping. Thus, Table 1 indicates that no current reference signal is readily compatible with RIS beam sweeping techniques.

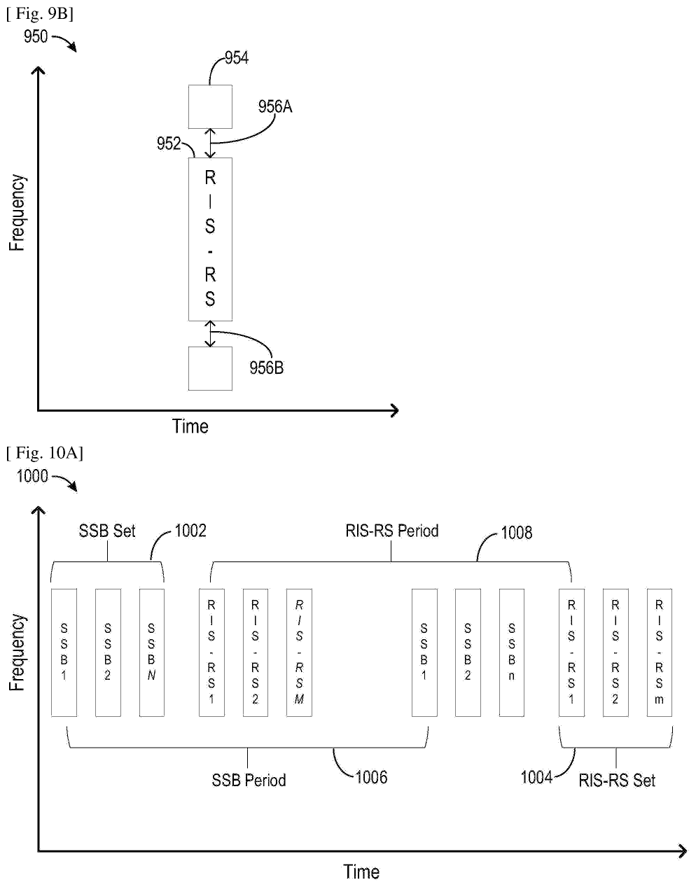

Accordingly, aspects described herein provide for a specialized (e.g., dedicated) reference signal, namely, a reconfigurable intelligent surface reference signal (RIS-RS). Generally, an RIS-RS may be used for measuring channel conditions between an RIS and, for example, a user equipment engaged in beam management with, for example, a network entity, such as a base station when the base station is using the RIS to reflect and/or refract signals to the user equipment. Beneficially, the user equipment in this example does not expect or need the network entity to configure QCL information (e.g., in a TCI) for the RIS-RS. And unlike synchronization signal blocks (SSBs), the RIS-RS is not associated with a physical broadcast channel (PBCH) (e.g., the RIS-RS may be independent of a PBCH), which beneficially avoids sharing SSB indexes between the network entity and the RIS, and which also reduces the signaling overhead in the air interface. Note that generally legacy SSBs include primary synchronization signals (PSS), secondary synchronization signals (SSS), and PBCH signals that are transmitted in a continuous group of symbols in the same slot such as depicted in the example of FIG. 9A, and further, legacy SSS and PSS are conventionally transmitted in a frequency range that is constrained by the PBCH resources. In this way, the legacy SSB may be associated with a PBCH. By contrast, an RIS-RS that is not associated with a PBCH has none of these resource allocation limitations (e.g., an RIS-RS can be sent without other resources, such as PSS, SSS, and PBCH, as shown in the example of FIG. 9B), and can be sent using a wider range of frequencies.

RIS-RS thus enable RISs to be incorporated into a wireless communications system, and more specifically to improve the capability of the wireless communications system to perform beamforming, which in-turn improves the overall function of the wireless communications system, such as by improving coverage, improving channel conditions, reducing interference, improving data throughput and speed, improving access, reducing latency, improving spectral efficiency, and reducing power consumption.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

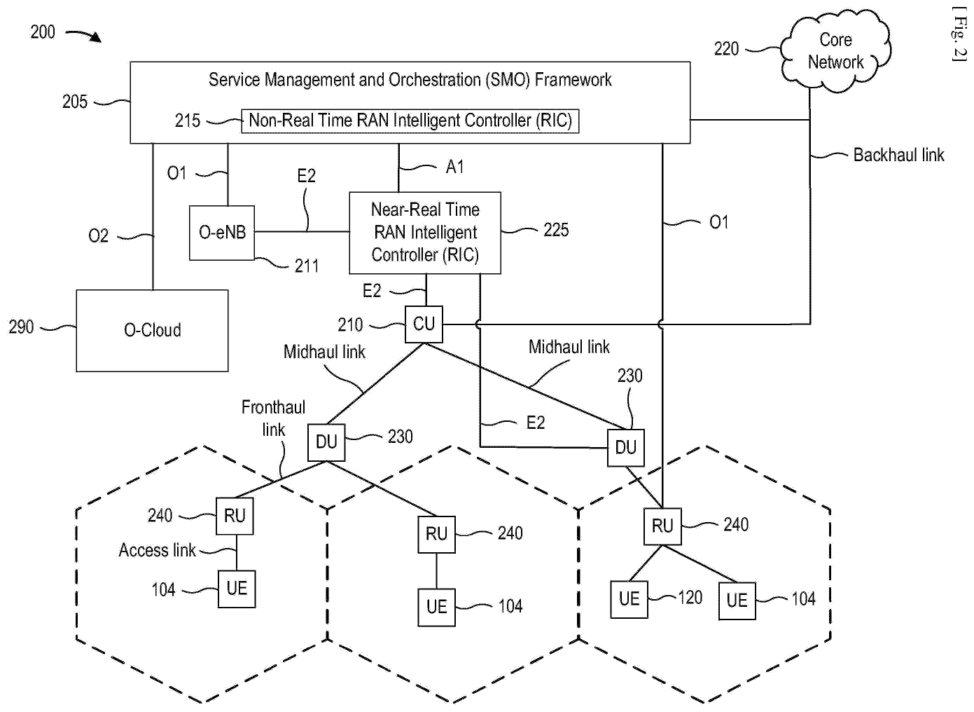

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an SI interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHZ-7125 MHz, which is often referred to (interchangeably) as “Sub-6 GHZ”. Similarly, 3GPP currently defines Frequency Range 2 (FR2) as including 24,250 MHz-52,600 MHz, which is sometimes referred to (interchangeably) as a “millimeter wave” (“mmW” or “mmWave”). A base station configured to communicate using mmWave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QOS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an Al interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-CNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via 01) or via creation of RAN management policies (such as A1 policies).

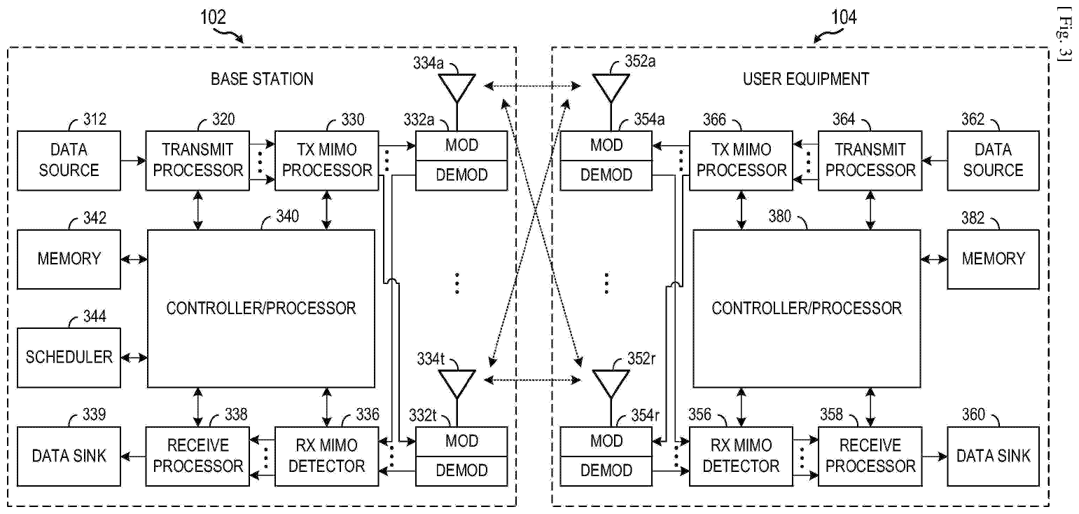

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols. MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

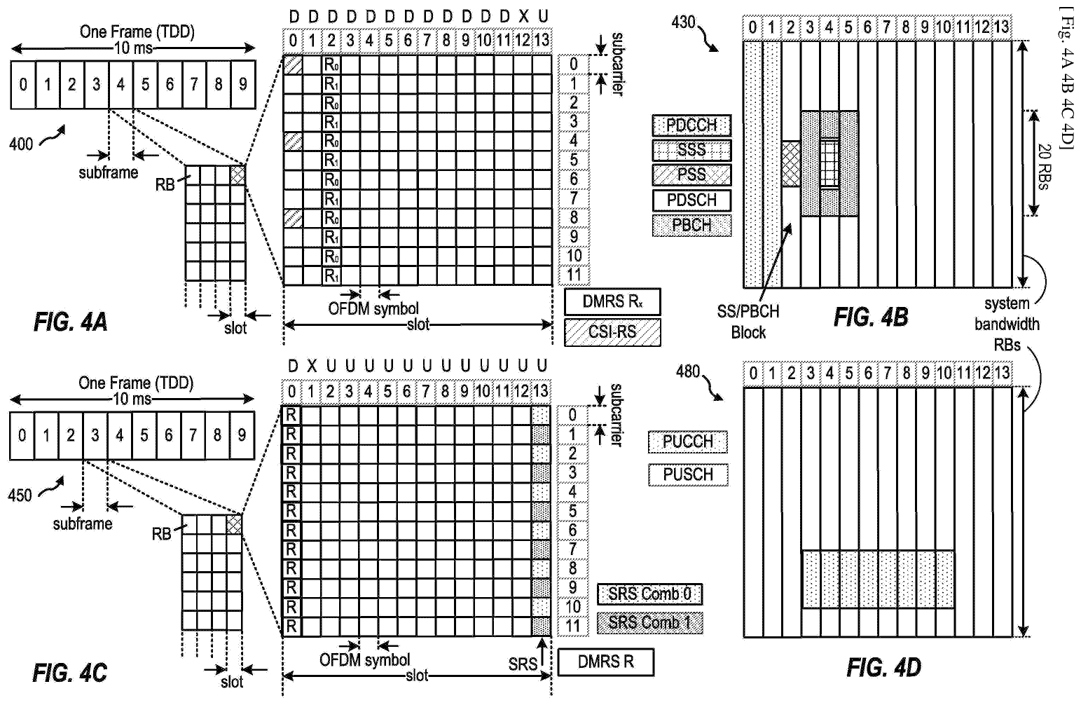

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD).

OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL. In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologics (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2^{μ}×15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Aspects Related to Reconfigurable Intelligent Surface Reference Signals

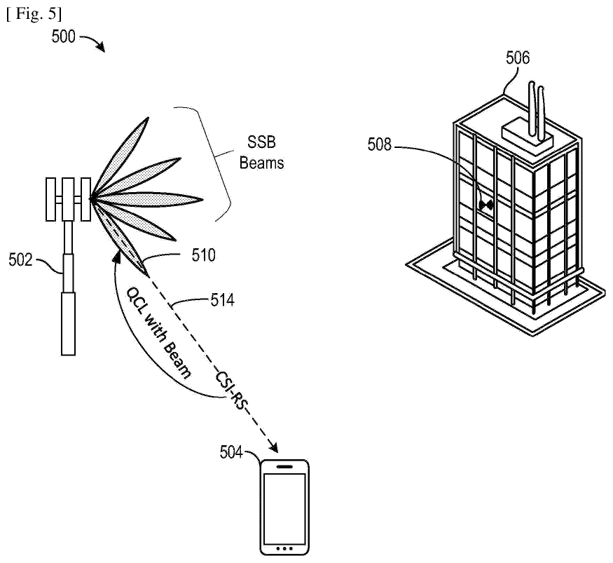

FIG. 5 depicts an example 500 of a beam sweeping procedure between a network entity 502 (e.g., a base station, as described above with respect to FIGS. 1-3) and a user equipment 504 (such as described above with respect to FIGS. 1 and 3). In particular, network entity 502 is transmitting a set of beams, such as SSBs (e.g., 510), in different directions so that user equipment 504 may measure the various beams and determine the best one or more beams for communications between network entity 502 and user equipment 504.

Network entity 502 may further refine the communication channel between itself and user equipment 504, e.g., after beam selection, using channel state information reference signals (e.g., CSI-RS 514), which may have a QCL relationship with a synchronization signal block (SSB). For example, as depicted in FIG. 5, CSI-RS 514 has a QCL relationship with (or is “quasi-collocated with”) beam 510. For example, user equipment 504 may be able to infer certain channel characteristics about CSI-RS 514 based on receiving SSB beam 510, including Doppler shift, average delay, and spatial characteristics. In some aspects, these inferable characteristics may be associated with so-called “type C” and “type D” QCL relationships as defined in 3GPP. The QCL relationship can assist user equipment 504 in obtaining measurements, such as received signal and received power (RSRP), which are useful for performing beam management.

In FIG. 5, a RIS 508 is depicted on building 506, but in this example, RIS 508 is not active. For example, network entity 502 has not scheduled RIS 508 to assist with communications from network entity 502 to user equipment 504 in this example.

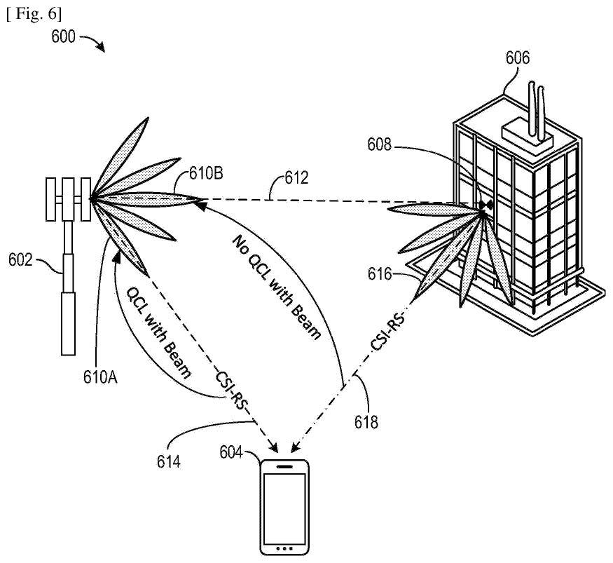

FIG. 6 depicts an example 600 of a beam sweeping procedure between a network entity 602 (e.g., a base station, as described above with respect to FIGS. 1-3), a RIS 608, and a user equipment 604 (such as described above with respect to FIGS. 1 and 3).

In this example, the CSI-RS 614, which is quasi-collocated with beam 610A (e.g., an SSB beam) is received by user equipment 604, just as in the example of FIG. 5. However, CSI-RS 618 is received by user equipment 604 by way of a reflection from RIS 608 (e.g., as part of a beam management procedure between RIS 608 and user equipment 604) located on building 606. Notably, CSI-RS 618 lacks a QCL relationship with beam 610B due to the reflection. This lack of QCL relationship can undermine conventional beam management procedures, such as beam sweeping.

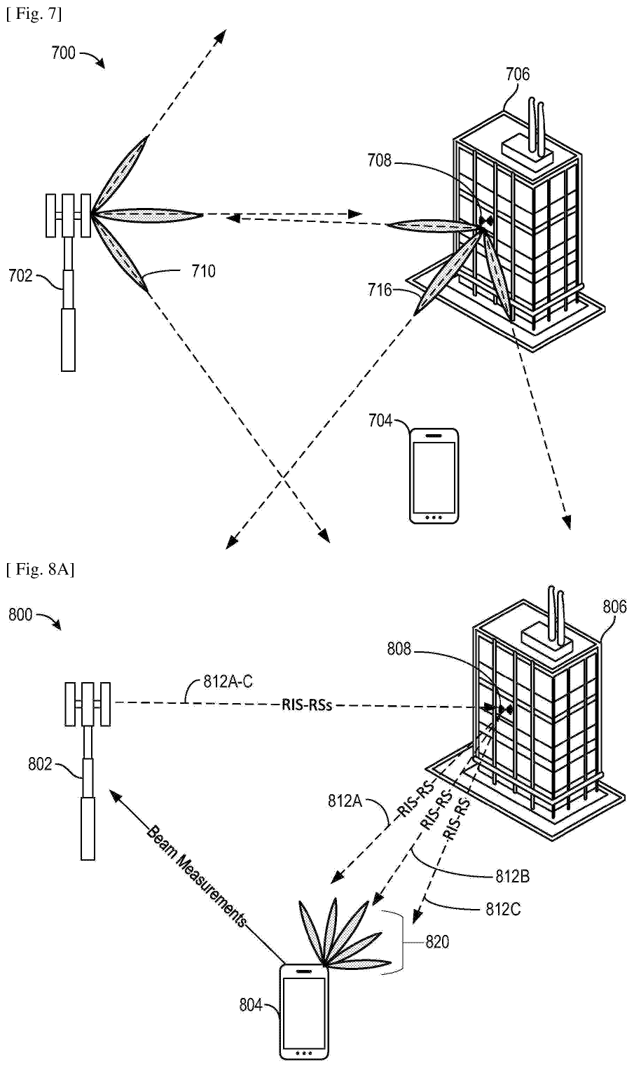

FIG. 7 depicts an example 700 of a beam sweeping procedure between a network entity 702 (e.g., a base station, as described above with respect to FIGS. 1-3), a RIS 708, and a user equipment 704 (such as described above with respect to FIGS. 1 and 3).

To overcome the issue depicted in FIG. 6 in which a reference signal reflected from an RIS lacks a QCL relationship with the original transmitter, the defined reference signals (such as SSBs) may be divided between network entity 702 and RIS 708, thereby enabling a QCL relationship between a reflected reference signal and the RIS. However, a challenge of using conventional reference signals in this manner for performing beam sweeping is that there are often a limited number of defined reference signals (e.g., a limited number of reference signal indexes). For example, there may be a limited number of defined SSBs that can be used in beam management. Generally speaking, beam sweeping is more effective with more defined beams because the beams can be tighter and thus provide more energy to a receiver, such as user equipment 704 when the best beam is selected. Referring back to Table 1, above, it is notable that the only conventional reference signal that does not need a QCL source, CSI-SSB, has the fewest number of indexed SSB of all available options.

Consequently, when splitting a limited number of defined reference signals (e.g., SSBs) between network entity 702 and RIS 708, a compromise must be made. Using narrower beams (e.g., 710 and 716) increases the chance of a failed beam sweeping procedure and/or a beam failure after beam selection because the limited number of beams from network entity 702 and RIS 708 have reduced directional coverage (as indicated by the various arrows bypassing user equipment 704). Alternatively, wider beams (not depicted) may increase directional coverage, but at the expense of reduced range and reduced signal quality at user equipment 704. Accordingly, in either case, splitting a limited number of defined reference signals (e.g., SSBs) between network entity 702 and RIS 708 creates a technical problem that reduces performance of wireless communications.

Note that while FIG. 7 depicts a simple example with a single network entity 702 and a single RIS 708 sharing defined reference signals (e.g., SSBs), actual wireless network deployments may have multiple RISs for every network entity, and thus the problem of splitting a finite number of defined reference signals is further exacerbated.

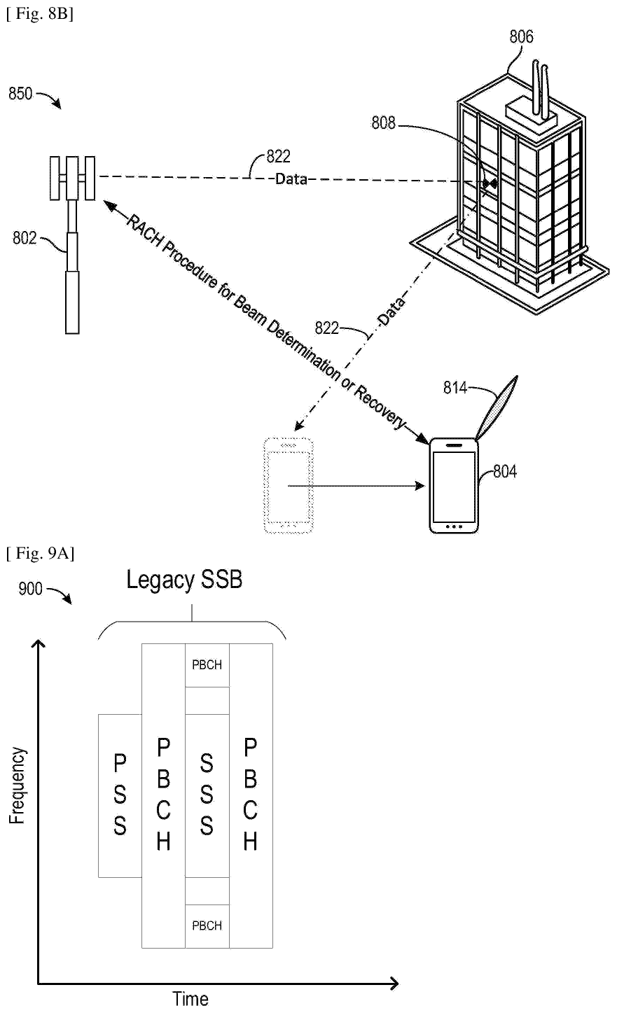

FIG. 8A depicts an example 800 of a beam sweeping procedure between a network entity 802 (e.g., a base station, as described above with respect to FIGS. 1-3), an RIS 808, and a user equipment 804 (such as described above with respect to FIGS. 1 and 3) using novel reconfigurable intelligent surface reference signals (RIS-RSs).

In particular, network entity 802 transmits a plurality of RIS-RS 812A-C to RIS 808, which reflects the RIS-RSs 812A-C in a plurality of directions, such as by applying different configurations across the surface of RIS 808 to RIS-RSs 812A-C. Generally, network entity 802 may send a set of RIS-RSs including a number of individual RIS-RSs based on the number of beams/directions that RIS 808 will reflect in order to perform beam sweeping with user equipment 804. In the depicted example, three RIS-RSs (812A-C) are depicted, but a different number may be used in different examples. For example, five RIS-RSs could be transmitted by network entity 802 and reflected off of RIS 808 in five different directions creating five different reference beams. Further, in some cases, network entity 802 may transmit more than one RIS-RS per reference beam reflected by RIS 808.

In this example, each of RIS-RSs 812A-C may be considered reference beams for performing beam management between user equipment 804 and RIS 808. The reflected RIS-RSs 812A-C are received by user equipment 804 and used to select a best receive beam (e.g., from receive beams 820) as part of a downlink beam sweeping procedure with RIS 808. Because RIS-RSs 812A-C are defined explicitly for performing beam management between RIS 808 and user equipment 818, RIS-RS 812A-C need not have a QCL relationship with any, for example, antenna port of network entity 802. Thus, unlike conventional reference signals reflected by RIS 808, such as SSBs transmitted by network entity 802, RIS-RSs 812A-C can be used for beam management between user equipment 804 and RIS 808 without compromises, such as without dividing reference signal indexes between devices or using suboptimal beam widths.

In instances where user equipment 804 has an RRC connection with network entity 802, user equipment 804 may further report user equipment 804's measurements of RIS-RSs 812-A-C(e.g., L1 beam measurements, such as received signal received power (RSRP), received signal strength indicator (RSSI), reference signal received quality (RSRQ), and others) back to network entity 802 for beam management.

Accordingly, RIS-RSs provide a technical solution to the aforementioned problems with conventional reference signals for beam management procedures, including beam/channel measurement between user equipment 804 and RIS 808. For example, no SSBs used by network entity 802 need be dedicated to performing the beam sweep procedure with user equipment 804 (as described with respect to the example of FIG. 5), the QCL requirement of for using existing references signals is avoided (as described with respect to FIG. 6), and a more accurate beam sweep procedure may be performed (e.g., as compared to the example of FIG. 7).

Generally, RIS-RSs may be dynamically configured on a device (e.g., user equipment 804) by a network (e.g., by network entity 802), or preconfigured on a device, with corresponding resource sets. Beneficially, whether dynamically or statically preconfigured, the network will not need to configure related QCL information in TCI for the RIS-RSs. However, unlike CSI-RS for radio resource management (RRM), resource indexes for RIS-RSs, can nevertheless be indicated in a QCL message included with TCI information that provides for a QCL source to other reference signals. The following is an example of TCI information that may be configured by a network:

| TCI-State : := | Sequence { |
|---|---|
| tci-StateId | TCI-StateId, |
| qcl-Type1 | QCL-info, |
| qcl-Type2 | QCL-info, |
| ... | |
| } | |
| QCL-info : := | Sequence { |
| cell | ServCellIndex |
| bwp-Id | BWP-Id |
| referenceSignal | CHOICE { |
| csi-rs | NZP-CSI-RS-ResourceID |
| ssb | SSB-Index |
| ris-rs | RIS-RS-Index |
| }, | |
| qcl-Type | ENUMERATED {typeA, typeB |

typeC, typeD},
...
}

In the preceding example of TCI information, the RIS-RS may be configured, for example, using existing NZP-CSI-RS-ResourceIDs or with a new RIS-RS-Index (italicized in the example above). Thus, implementing RIS-RSs within existing standards may be achieved in various manners.

Further, RIS-RSs can generally be configured as periodic, semi-periodic, or aperiodic by the communications network.

FIG. 8B depicts an example scenario 850 in which a beam failure occurs between RIS 808 and user equipment 804.

For example, user equipment 804 may move outside of an effective area for an originally determined beam for data transmission 822 from network entity 802 to user equipment by way of RIS 808. This movement may also cause misalignment of user equipment 804's selected receive beam 814 with respect to RIS 808's reflected data transmission 822. In such a scenario, user equipment may initiate a random access channel (RACH) procedure directly with network entity 802 in order to perform beam recovery.

Similarly, if a beam determination procedure fails, such as network entity 802 and user equipment 804 cannot determine a suitable beam pair between user equipment 804 and RIS 808 (e.g., UE 804 fails radio link management), then user equipment 804 can request an RIS-RS transmission from network entity 802 via RACH via a direct link between user equipment 804 and network entity 802.

FIG. 9A depicts an example of a data structure 900 for a conventional SSB, which includes time and frequency resources for a primary synchronization signal (PSS), physical broadcast channel (PBCH), and secondary synchronization signal (SSS). Such an SSB may be associated with the various SSB beams described above. As shown in FIG. 9A, the conventional SSB is associated with a PBCH by the PSS, SSS, and PBCH signals being transmitted in a continuous group of symbols in a same slot.

FIG. 9B depicts an example of a data structure 950 for an RIS-RS 952. Unlike conventional SSB reference signals, RIS-RSs need not be associated with a physical broadcast channel (PBCH), so resource sets for RIS-RS can be more compact in terms of allocated time and frequency resources, which as above, reduces signaling overhead on the air interface. For example, an RIS-RS that is not associated with a PBCH may not be transmitted (nor include PSS and/or SSS that are transmitted) in a continuous group of symbols in the same slot with a PBCH. Further, as above, the RIS-RS may use a wider range or different range of frequencies than, for example, a PBCH because the RIS-RS is not constrained by an associated PBCH. For example, an RIS-RS that is not associated with a PBCH may be transmitted outside a frequency range used for a PBCH. In some aspects, a given set of RIS-RS resources (e.g., 952) may be considered a lightweight SSB.

In one example, RIS-RS 952 may include a sequence, such as a gold sequence, m-sequence, or other type of sequence. For example, RIS-RS 952 may include a 127 bit gold sequence with 336 possible values. Other implementations are possible.

Further, RIS-RS 952 may be configured with defined gaps (e.g., 956A and 956B) to other data (e.g., 954) configured in adjacent time and frequency resources.

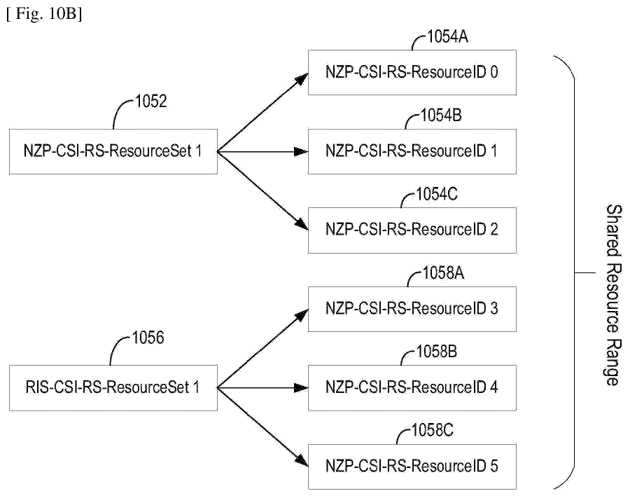

FIG. 10A depicts an example 1000 of concurrent scheduling of sets of SSBs and RIS-RSs. In particular, sets or “bursts” of SSBs (e.g., SSB1-SSBM), such as 1002, may be scheduled according to an SSB period 1006. Similarly, sets or bursts of RIS-RS (e.g., RIS-RS1-RIS-RSN), such as 1004, may be scheduled according to an RIS-RS period 1008.

Note that FIG. 10A is just one example, and many other configurations are possible. For example, different RISs can be configured with different RIS-RS sets, and those different RIS-RS sets may have different periodicities, including periodic, semi-periodic, and aperiodic. Further, in some aspects, RIS-RSs within the same RIS-RS set (e.g., 1004) can use the same sequence as payload, while RIS-RSs in different sets can have different sequences as payload.

FIG. 10B depicts an example of sharing resource ranges for defining RIS-RS (and other reference signal) sets. In this example, NZP-CSI-RS resource set 1052 defines CSI-RS resources 1054A-1054C. Similarly, RIS-CSI-RS resource set 1056 defines RIS-RS resources 1058A-1058C (e.g., for a set of resources such as 1004 in FIG. 10A) by sharing the existing NZP-CSI-RS resource ID range. Thus, FIG. 10B depicts another way to integrate new reference signals, such as RIS-RSs, into an existing standards framework.

### Example Operations in a Communications Network Using RIS-RS

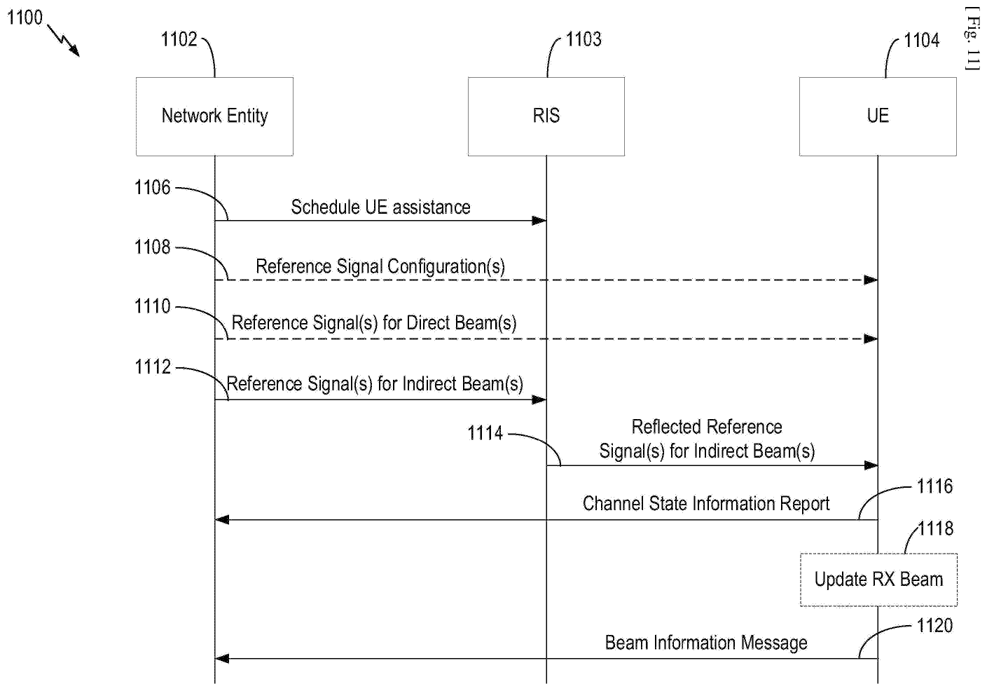

FIG. 11 depicts a process flow 1100 for performing beam management in a communications network between a network entity 1102, an RIS 1103, and a user equipment (UE) 1104. As discussed herein, RIS 1103 is a device that changes characteristics of an impinging electromagnetic wave and which may be either reflective or refractive or which may be both reflective and refractive

In some aspects, the network entity 1102 may be an example of the BS 102 depicted and described with respect to FIGS. 1 and 3 or a disaggregated base station depicted and described with respect to FIG. 2. Similarly, the UE 1104 may be an example of UE 104 depicted and described with respect to FIGS. 1 and 3. However, in other aspects, UE 104 may be another type of wireless communications device and BS 102 may be another type of network entity or network node, such as those described herein.

Flow 1100 beings at 1106 where network entity 1102 schedules RIS 1103 to provide assistance to UE 1104, such as by reflecting signals from network entity 1102 to UE 1104 (e.g., as depicted in FIGS. 6 and 8A).

Flow 1100 then proceeds to 1108 where network entity 1102 optionally configures RIS-RSs on UE 1104. As described above, in other examples, UE 1104 may already be configured with RIS-RSs.

Flow 1100 then proceeds to 1110 where network entity 1102 optionally configures reference signals (e.g., SSB and/or CSI-RS) for beams that UE 1104 will directly receive (e.g., referred to as direct beams), such as beam 610A in FIG. 6.

Flow 1100 then proceeds to 1112 where network entity 1102 sends reference signals to RIS 1103, which RIS 1103 then reflects (e.g., via modulation of a metasurface) to UE 1104 at 1114. As these beams arrive at UE 1104 via RIS 1103, they are referred to as indirect beams, such as beam 816 in FIG. 8A.

Flow 1100 then proceeds to step 1116 where UE 1104 sends a channel state information reporting (e.g., including channel measurements related to the channel between UE 1104 and RIS 1103) to network entity 1102. In some aspects, these measurements may include L1 measurements, such as RSRP measurements.

Flow 1100 then proceeds to step 1118 where UE 1104 optionally updates is receiving beam based on, for example, the channel state measurements sent to network entity 1102.

Flow 1100 then proceeds to step 1120 where UE 1104 sends a beam information message to network entity 1102. For example, the beam information message may indicate one or more preferred beams (e.g., beam 816 in FIG. 8A) for receiving signals from network entity 1102 by way of RIS 1103.

### Example Operations of a Network Entity

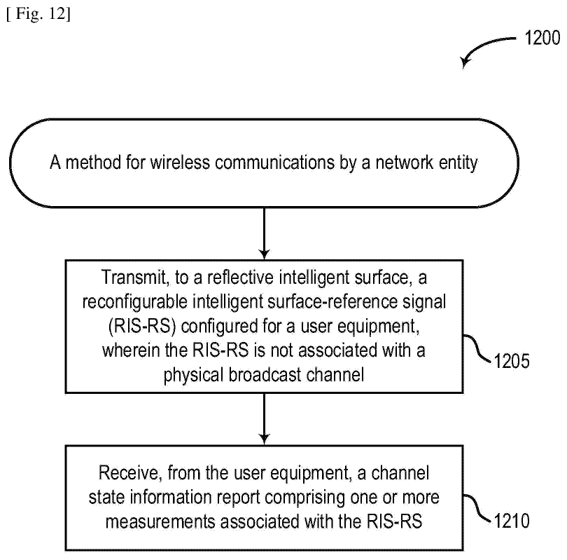

FIG. 12 shows a method 1200 for wireless communications by a network entity, such as BS 102 of FIGS. 1 and 3, or a disaggregated base station as discussed with respect to FIG. 2.

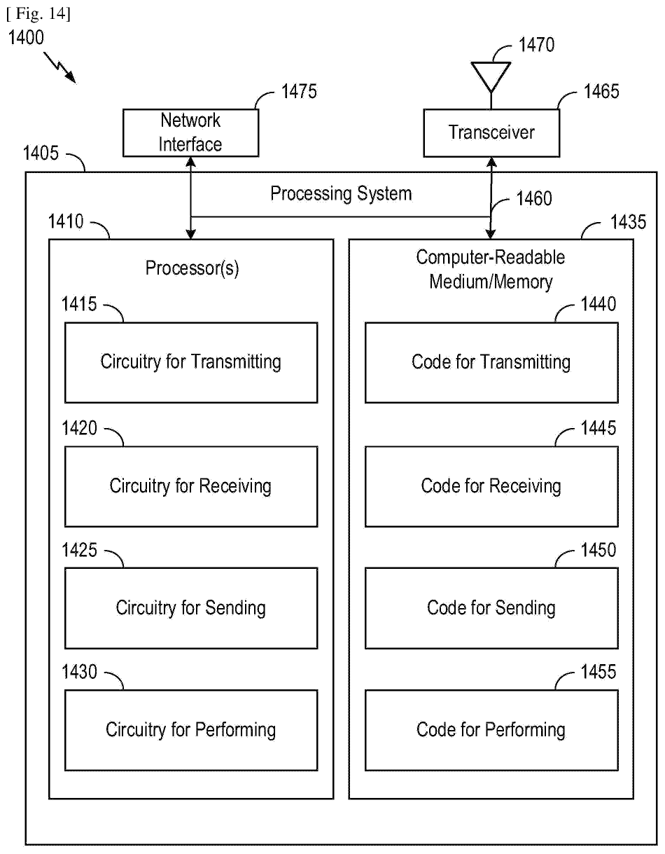

Method 1200 begins at 1205 with transmitting, to an RIS, an RIS-RS configured for a user equipment, wherein the RIS-RS is not associated with a PBCH. In some aspects, the operations of this step refer to, or may be performed by, transmitting circuitry as described with reference to FIG. 14.

Method 1200 then proceeds to step 1210 with receiving, from the user equipment, a CSI report comprising one or more measurements associated with the RIS-RS. In some aspects, the operations of this step refer to, or may be performed by, receiving circuitry as described with reference to FIG. 14. In some aspects, one of the one or more measurements comprises a layer 1 RSRP measurement.

In some aspects, the method 1200 further includes transmitting, to the user equipment, a configuration for the RIS-RS, wherein the configuration for the RIS-RS comprises a resource set configured for measuring a channel between the RIS and the user equipment, such as described above with respect to FIG. 11. In some aspects, the operations of this step refer to, or may be performed by, transmitting circuitry as described with reference to FIG. 14.

In some aspects, the configuration schedules the RIS-RS periodically, such as described with respect to FIG. 10A. In some aspects, the configuration schedules the RIS-RS semi-periodically. In some aspects, the configuration schedules the RIS-RS aperiodically.

In some aspects, the configuration comprises one or more sequences. In some aspects, at least one of the one or more sequences is a gold sequence or an m-sequence.

In some aspects, the configuration indicates one or more RIS-RS sets (e.g., as described with respect to FIG. 10A), and the RIS-RS is included in one of the one or more RIS-RS sets.

In some aspects, the configuration indicates a plurality of RIS-RS sets, wherein each respective RIS-RS set of the plurality of RIS-RS sets is configured with a respective sequence for each RIS-RS included in a respective RIS-RS set, and wherein RIS-RSs in different RIS-RS sets of the plurality of RIS-RS sets have different sequences from one another, such as described with respect to FIG. 10A.

In some aspects, the configuration indicates one or more time and frequency locations associated with the RIS-RS, and the one or more time and frequency locations define one or more gap resources between the RIS-RS and other time and frequency locations associated with a data transmission, such as described with respect to FIG. 9B.

In some aspects, the method 1200 further includes transmitting, to the user equipment, a CSI-RS, wherein the RIS-RS is not quasi-collocated with the CSI-RS, such as described with respect to FIGS. 6 and 8A. In some aspects, the operations of this step refer to, or may be performed by, transmitting circuitry as described with reference to FIG. 14.

In some aspects, the method 1200 further includes transmitting, to the user equipment, an SSB, wherein the RIS-RS is not quasi-collocated with the SSB, such as described with respect to FIGS. 6 and 8A. In some aspects, the operations of this step refer to, or may be performed by, transmitting circuitry as described with reference to FIG. 14.

In some aspects, the method 1200 further includes transmitting, to the user equipment, QCL information comprising an index associated with the RIS-RS. In some aspects, the index is indicated by a NZP-CSI-RS-ResourceID, such as described with respect to FIG. 10B. In some aspects, the operations of this step refer to, or may be performed by, transmitting circuitry as described with reference to FIG. 14.

In some aspects, the method 1200 further includes receiving, from the user equipment, a first beam report comprising one or more measurements associated with one or more direct beams, wherein the one or more direct beams are transmitted from the network entity to the user equipment. In some aspects, the operations of this step refer to, or may be performed by, receiving circuitry as described with reference to FIG. 14.

In some aspects, the method 1200 further includes receiving, from the user equipment, a second beam report comprising one or more measurements associated with one or more indirect beams. In some aspects, the operations of this step refer to, or may be performed by, receiving circuitry as described with reference to FIG. 14. In some aspects, the one or more indirect beams are not transmitted by the network entity to the user equipment.

In some aspects, the method 1200 further includes receiving, from the user equipment, a beam report comprising one or more measurements associated with one or more direct beams and one or more measurements associated with one or more indirect beams. In some aspects, the operations of this step refer to, or may be performed by, receiving circuitry as described with reference to FIG. 14. In some aspects, the one or more direct beams are transmitted from the network entity to the user equipment, and wherein the one or more indirect beams are not transmitted by the network entity to the user equipment.

In some aspects, the method 1200 further includes performing timing refinement based on the one or more measurements associated with the RIS-RS. In some aspects, the operations of this step refer to, or may be performed by, performing circuitry as described with reference to FIG. 14.

In some aspects, the method 1200 further includes receiving, from the user equipment, a request for transmission of the RIS-RS over a RACH, wherein transmitting, to the user equipment, the RIS-RS is performed over the RACH. In some aspects, the operations of this step refer to, or may be performed by, receiving circuitry as described with reference to FIG. 14.

In one aspect, method 1200, or any aspect related thereto, may be performed by an apparatus, such as communications device 1400 of FIG. 14, which includes various components operable, configured, or adapted to perform the method 1200. Communications device 1400 is described below in further detail.

Note that FIG. 12 is just one example of a method, and other methods including fewer, additional, or alternative steps are possible consistent with this disclosure.

### Example Operations of a User Equipment

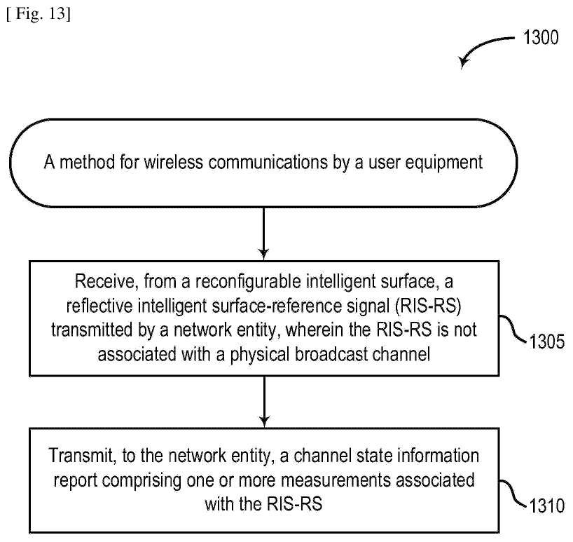

FIG. 13 shows a method 1300 for wireless communications by a UE, such as UE 104 of FIGS. 1 and 3.

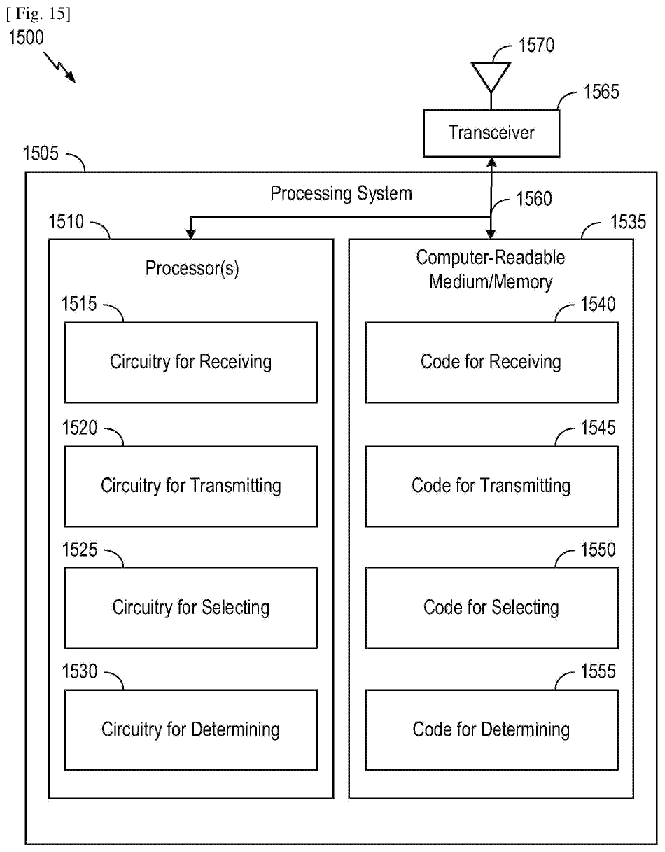

Method 1300 begins at 1305 with receiving, from a reconfigurable intelligent surface, a RIS-RS transmitted by a network entity, such as RIS-RS 812 in FIG. 9A. In some aspects, the RIS-RS is not associated with a PBCH, such as described with respect to FIG. 9B. In some cases, the operations of this step refer to, or may be performed by, circuitry for receiving as described with reference to FIG. 15.

Method 1300 then proceeds to step 1310 with transmitting, to the network entity, a CSI report comprising one or more measurements associated with the RIS-RS, such as described with respect to step 1116 in FIG. 11. In some aspects, one of the one or more measurements comprises a layer 1 RSRP measurement. In some cases, the operations of this step refer to, or may be performed by, circuitry for transmitting as described with reference to FIG. 15.

In some aspects, the method 1300 further includes receiving, from the network entity, a configuration for the RIS-RS. In some aspects, the configuration for the RIS-RS comprises a resource set configured for measuring a channel between the RIS and the user equipment. In some cases, the operations of this step refer to, or may be performed by, circuitry for receiving as described with reference to FIG. 15.

In some aspects, the configuration schedules the RIS-RS periodically. In some aspects, the configuration schedules the RIS-RS semi-periodically. In some aspects, the configuration schedules the RIS-RS aperiodically.

In some aspects, the configuration comprises a gold sequence.

In some aspects, the configuration indicates one or more RIS-RS sets (e.g., RIS-RS set 1004 in FIG. 10A), and the RIS-RS is associated with one of the one or more RIS-RS sets. In some aspects, each respective RIS-RS set of the one or more RIS-RS sets is configured with respective sequence for each of the respective RIS-RS set's associated RIS-RSs different from each other RIS-RS set of the one or more RIS-RS sets.

In some aspects, the configuration indicates one or more time and frequency locations associated with the RIS-RS, and the one or more time and frequency locations define one or more gap resources between the RIS-RS and any other time and frequency locations associated with a data transmission, such as described with respect to FIG. 9B.

In some aspects, the method 1300 further includes receiving, from the network entity, a CSI-RS, wherein the RIS-RS is not quasi-collocated with the CSI-RS. In some aspects, the method 1300 further includes receiving, from the network entity, a SSB, wherein the RIS-RS is not quasi-collocated with the SSB.

In some aspects, the method 1300 further includes receiving, from the network entity, QCL information comprising an index associated with the RIS-RS. In some aspects, the index comprises a NZP-CSI-RS-ResourceID, such as described with respect to FIG. 10B. In some cases, the operations of this step refer to, or may be performed by, circuitry for receiving as described with reference to FIG. 15.

In some aspects, the method 1300 further includes transmitting, to the network entity, a first beam report comprising one or more measurements associated with one or more direct beams, such as described with respect to step 1120 of FIG. 11. In some aspects, the one or more direct beams are transmitted from the network entity to the user equipment. In some cases, the operations of this step refer to, or may be performed by, circuitry for transmitting as described with reference to FIG. 15.

In some aspects, the method 1300 further includes transmitting, to the network entity, a second beam report comprising one or more measurements associated with one or more indirect beams. In some aspects, the one or more indirect beams are not transmitted by the network entity to the user equipment. In some cases, the operations of this step refer to, or may be performed by, circuitry for transmitting as described with reference to FIG. 15.

In some aspects, the method 1300 further includes transmitting, to the network entity, a beam report comprising one or more measurements associated with one or more direct beams and one or more measurements associated with one or more indirect beams, wherein the one or more direct beams are received from the network entity, and wherein the one or more indirect beams are received from a RIS. In some cases, the operations of this step refer to, or may be performed by, circuitry for transmitting as described with reference to FIG. 15.

In some aspects, the method 1300 further includes transmitting, to the network entity, a request for transmission of the RIS-RS over a RACH. In some cases, the operations of this step refer to, or may be performed by, circuitry for transmitting as described with reference to FIG. 15. In some aspects, receiving, from the network entity, the RIS-RS is performed over the RACH.

In some aspects, the method 1300 further includes selecting a new receive beam based on the one or more measurements associated with the RIS-RS, such as described with respect to step 1118 in FIG. 11. In some cases, the operations of this step refer to, or may be performed by, circuitry for selecting as described with reference to FIG. 15.

In some aspects, the method 1300 further includes determining a beam failure based on the RIS-RS, such as described with respect to FIG. 8B. In some cases, the operations of this step refer to, or may be performed by, circuitry for determining as described with reference to FIG. 15.

In one aspect, method 1300, or any aspect related thereto, may be performed by an apparatus, such as communications device 1500 of FIG. 15, which includes various components operable, configured, or adapted to perform the method 1300. Communications device 1500 is described below in further detail.

Note that FIG. 13 is just one example of a method, and other methods including fewer, additional, or alternative steps are possible consistent with this disclosure.

### Example Communications Devices

FIG. 14 depicts aspects of an example communications device 1400. In some aspects, communications device 1400 is a network entity, such as BS 102 of FIGS. 1 and 3, or a disaggregated base station as discussed with respect to FIG. 2.

The communications device 1400 includes a processing system 1405 coupled to the transceiver 1465 (e.g., a transmitter and/or a receiver) and/or a network interface 1475. The transceiver 1465 is configured to transmit and receive signals for the communications device 1400 via the antenna 1470, such as the various signals as described herein. The network interface 1475 is configured to obtain and send signals for the communications device 1400 via communication link(s), such as a backhaul link, midhaul link, and/or fronthaul link as described herein, such as with respect to FIG. 2. The processing system 1405 may be configured to perform processing functions for the communications device 1400, including processing signals received and/or to be transmitted by the communications device 1400.

The processing system 1405 includes one or more processors 1410. In various aspects, one or more processors 1410 may be representative of one or more of receive processor 338, transmit processor 320, TX MIMO processor 330, and/or controller/processor 340, as described with respect to FIG. 3. The one or more processors 1410 are coupled to a computer-readable medium/memory 1435 via a bus 1460. In certain aspects, the computer-readable medium/memory 1435 is configured to store instructions (e.g., computer-executable code) that when executed by the one or more processors 1410, cause the one or more processors 1410 to perform the method 1200 described with respect to FIG. 12, or any aspect related thereto. Note that reference to a processor of communications device 1400 performing a function may include one or more processors 1410 of communications device 1400 performing that function.

In the depicted example, the computer-readable medium/memory 1435 stores code (e.g., executable instructions), such as code for transmitting 1440, code for receiving 1445, code for sending 1450, and code for performing 1455. Processing of the code for transmitting 1440, code for receiving 1445, code for sending 1450, and code for performing 1455 may cause the communications device 1400 to perform the method 1200 described with respect to FIG. 12, or any aspect related thereto.

The one or more processors 1410 include circuitry configured to implement (e.g., execute) the code stored in the computer-readable medium/memory 1435, including circuitry such as circuitry for transmitting 1415, circuitry for receiving 1420, circuitry for sending 1425, and circuitry for performing 1430. Processing with circuitry for transmitting 1415, circuitry for receiving 1420, circuitry for sending 1425, and circuitry for performing 1430 may cause the communications device 1400 to perform the method 1200 as described with respect to FIG. 12, or any aspect related thereto.

Various components of the communications device 1400 may provide means for performing the method 1200 as described with respect to FIG. 12, or any aspect related thereto. Means for transmitting, sending or outputting for transmission may include transceivers 332 and/or antenna(s) 334 of the BS 102 illustrated in FIG. 3 and/or the transceiver 1465 and the antenna 1470 of the communications device 1400 in FIG. 14. Means for receiving or obtaining may include transceivers 332 and/or antenna(s) 334 of the BS 102 illustrated in FIG. 3 and/or the transceiver 1465 and the antenna 1470 of the communications device 1400 in FIG. 14.

FIG. 15 depicts aspects of an example communications device 1500. In some aspects, communications device 1500 is a user equipment, such as UE 104 described above with respect to FIGS. 1 and 3.

The communications device 1500 includes a processing system 1505 coupled to the transceiver 1565 (e.g., a transmitter and/or a receiver). The transceiver 1565 is configured to transmit and receive signals for the communications device 1500 via the antenna 1570, such as the various signals as described herein. The processing system 1505 may be configured to perform processing functions for the communications device 1500, including processing signals received and/or to be transmitted by the communications device 1500.

The processing system 1505 includes one or more processors 1510. In various aspects, the one or more processors 1510 may be representative of one or more of receive processor 358, transmit processor 364, TX MIMO processor 366, and/or controller/processor 380, as described with respect to FIG. 3. The one or more processors 1510 are coupled to a computer-readable medium/memory 1535 via a bus 1560. In certain aspects, the computer-readable medium/memory 1535 is configured to store instructions (e.g., computer-executable code) that when executed by the one or more processors 1510, cause the one or more processors 1510 to perform the method 1300 described with respect to FIG. 13, or any aspect related thereto. Note that reference to a processor performing a function of communications device 1500 may include one or more processors 1510 performing that function of communications device 1500.

In the depicted example, computer-readable medium/memory 1535 stores code (e.g., executable instructions), such as code for receiving 1540, code for transmitting 1545, code for selecting 1550, and code for determining 1555. Processing of the code for receiving 1540, code for transmitting 1545, code for selecting 1550, and code for determining 1555 may cause the communications device 1500 to perform the method 1300 described with respect to FIG. 13, or any aspect related thereto.

The one or more processors 1510 include circuitry configured to implement (e.g., execute) the code stored in the computer-readable medium/memory 1535, including circuitry such as circuitry for receiving 1515, circuitry for transmitting 1520, circuitry for selecting 1525, and circuitry for determining 1530. Processing with circuitry for receiving 1515, circuitry for transmitting 1520, circuitry for selecting 1525, and circuitry for determining 1530 may cause the communications device 1500 to perform the method 1300 described with respect to FIG. 13, or any aspect related thereto.

Various components of the communications device 1500 may provide means for performing the method 1300 described with respect to FIG. 13, or any aspect related thereto. For example, means for transmitting, sending or outputting for transmission may include transceivers 354 and/or antenna(s) 352 of the UE 104 illustrated in FIG. 3 and/or the transceiver 1565 and the antenna 1570 of the communications device 1500 in FIG. 15. Means for receiving or obtaining may include transceivers 354 and/or antenna(s) 352 of the UE 104 illustrated in FIG. 3 and/or the transceiver 1565 and the antenna 1570 of the communications device 1500 in FIG. 15.

### Example Clauses

Implementation examples are described in the following numbered clauses:
Clause 1: A method of wireless communications by a network entity, comprising: transmitting, to a RIS, a RIS-RS configured for a user equipment, wherein the RIS-RS is not associated with a PBCH and receiving, from the user equipment, a CSI report comprising one or more measurements associated with the RIS-RS.
Clause 2: The method of Clause 1, further comprising: transmitting, to the user equipment, a configuration for the RIS-RS, wherein the configuration for the RIS-RS comprises a resource set configured for measuring a channel between the RIS and the user equipment.
Clause 3: The method of Clause 2, wherein the configuration schedules the RIS-RS periodically.
Clause 4: The method of Clause 2, wherein the configuration schedules the RIS-RS semi-periodically.
Clause 5: The method of Clause 2, wherein the configuration schedules the RIS-RS aperiodically.
Clause 6: The method of Clause 2, wherein the configuration comprises one or more sequences.
Clause 7: The method of Clause 6, wherein at least one of the one or more sequences is a gold sequence or an m-sequence.
Clause 8: The method of Clause 2, wherein: the configuration indicates one or more RIS-RS sets, and the RIS-RS is included in one of the one or more RIS-RS sets.
Clause 9: The method of Clause 2, wherein the configuration indicates a plurality of RIS-RS sets, wherein each respective RIS-RS set of the plurality of RIS-RS sets is configured with a respective sequence for each RIS-RS included in a respective RIS-RS set, and wherein RIS-RSs in different RIS-RS sets of the plurality of RIS-RS sets have different sequences from one another.
Clause 10: The method of Clause 2, wherein: the configuration indicates one or more time and frequency locations associated with the RIS-RS, and the one or more time and frequency locations define one or more gap resources between the RIS-RS and other time and frequency locations associated with a data transmission.
Clause 11: The method of any one of Clauses 1-10, further comprising: transmitting, to the user equipment, a CSI-RS, wherein the RIS-RS is not quasi-collocated with the CSI-RS.
Clause 12: The method of Clause 11, further comprising: transmitting, to the user equipment, a SSB, wherein the RIS-RS is not quasi-collocated with the SSB.
Clause 13: The method of any one of Clauses 1-12, further comprising: transmitting, to the user equipment, QCL information comprising an index associated with the RIS-RS.
Clause 14: The method of Clause 13, wherein the index is indicated by a NZP-CSI-RS-ResourceID.
Clause 15: The method of any one of Clauses 1-14, wherein one of the one or more measurements comprises a layer 1 RSRP measurement.
Clause 16: The method of any one of Clauses 1-15, further comprising: receiving, from the user equipment, a first beam report comprising one or more measurements associated with one or more direct beams, wherein the one or more direct beams are transmitted from the network entity to the user equipment; and receiving, from the user equipment, a second beam report comprising one or more measurements associated with one or more indirect beams.
Clause 17: The method of any one of Clauses 1-16, further comprising: receiving, from the user equipment, a beam report comprising one or more measurements associated with one or more direct beams and one or more measurements associated with one or more indirect beams, wherein the one or more direct beams are transmitted from the network entity to the user equipment, and wherein the one or more indirect beams are not transmitted by the network entity to the user equipment.
Clause 18: The method of any one of Clauses 1-17, further comprising: performing timing refinement based on the one or more measurements associated with the RIS-RS.
Clause 19: The method of any one of Clauses 1-18, further comprising: receiving, from the user equipment, a request for transmission of the RIS-RS over a RACH, wherein transmitting, to the user equipment, the RIS-RS is performed over the RACH.
Clause 20: A method of wireless communications by a user equipment, comprising: receiving, from a reconfigurable intelligent surface, a RIS-RS transmitted by a network entity, wherein the RIS-RS is not associated with a PBCH and transmitting, to the network entity, a CSI report comprising one or more measurements associated with the RIS-RS.
Clause 21: The method of Clause 20, further comprising: receiving, from the network entity, a configuration for the RIS-RS, wherein the configuration for the RIS-RS comprises a resource set configured for measuring a channel between the RIS and the user equipment.
Clause 22: The method of Clause 21, wherein the configuration schedules the RIS-RS periodically.
Clause 23: The method of Clause 21, wherein the configuration schedules the RIS-RS semi-periodically.
Clause 24: The method of Clause 21, wherein the configuration schedules the RIS-RS aperiodically.
Clause 25: The method of Clause 21, wherein the configuration comprises a gold sequence.
Clause 26: The method of Clause 21, wherein: the configuration indicates one or more RIS-RS sets, and the RIS-RS is associated with one of the one or more RIS-RS sets.
Clause 27: The method of Clause 26, wherein each respective RIS-RS set of the one or more RIS-RS sets is configured with respective sequence for each of the respective RIS-RS set's associated RIS-RSs different from each other RIS-RS set of the one or more RIS-RS sets.
Clause 28: The method of Clause 21, wherein: the configuration indicates one or more time and frequency locations associated with the RIS-RS, and the one or more time and frequency locations define one or more gap resources between the RIS-RS and any other time and frequency locations associated with a data transmission.
Clause 29: The method of any one of Clauses 20-28, further comprising: receiving, from the network entity, a CSI-RS, wherein the RIS-RS is not quasi-collocated with the CSI-RS.
Clause 30: The method of Clause 29, further comprising: receiving, from the network entity, a SSB, wherein the RIS-RS is not quasi-collocated with the SSB.
Clause 31: The method of any one of Clauses 20-30, further comprising: receiving, from the network entity, QCL information comprising an index associated with the RIS-RS.
Clause 32: The method of Clause 31, wherein the index comprises a NZP-CSI-RS-ResourceID.
Clause 33: The method of any one of Clauses 20-32, wherein one of the one or more measurements comprises a layer 1 RSRP measurement.
Clause 34: The method of any one of Clauses 20-33, further comprising: transmitting, to the network entity, a first beam report comprising one or more measurements associated with one or more direct beams, wherein the one or more direct beams are transmitted from the network entity to the user equipment; and transmitting, to the network entity, a second beam report comprising one or more measurements associated with one or more indirect beams.
Clause 35: The method of any one of Clauses 20-34, further comprising: transmitting, to the network entity, a beam report comprising one or more measurements associated with one or more direct beams and one or more measurements associated with one or more indirect beams, wherein the one or more direct beams are received from the network entity, and wherein the one or more indirect beams are received from a RIS.
Clause 36: The method of any one of Clauses 20-35, further comprising: transmitting, to the network entity, a request for transmission of the RIS-RS over a RACH, wherein receiving, from the network entity, the RIS-RS is performed over the RACH.
Clause 37: The method of any one of Clauses 20-36, further comprising: selecting a new receive beam based on the one or more measurements associated with the RIS-RS.
Clause 38: The method of any one of Clauses 20-37, further comprising: determining a beam failure based on the RIS-RS.
Clause 39: A processing system, comprising: a memory comprising computer-executable instructions; one or more processors configured to execute the computer-executable instructions and cause the processing system to perform a method in accordance with any one of Clauses 1-38.
Clause 40: A processing system, comprising means for performing a method in accordance with any one of Clauses 1-38.
Clause 41: A non-transitory computer-readable medium comprising computer-executable instructions that, when executed by one or more processors of a processing system, cause the processing system to perform a method in accordance with any one of Clauses 1-38.
Clause 42: A computer program product embodied on a computer-readable storage medium comprising code for performing a method in accordance with any one of Clauses 1-38.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A network entity configured for wireless communications, comprising:
a memory comprising computer-executable instructions; and
one or more processors configured to execute the computer-executable instructions and cause the network entity to:
transmit, to a reconfigurable intelligent surface (RIS), a reconfigurable intelligent surface reference signal (RIS-RS) configured for a user equipment, wherein the RIS-RS is not associated with a physical broadcast channel (PBCH); and
receive, from the user equipment, a channel state information (CSI) report comprising one or more measurements associated with the RIS-RS.

2. The network entity of claim 1, wherein the one or more processors are configured to execute the computer-executable instructions and further cause the network entity to:
transmit, to the user equipment, a configuration for the RIS-RS, wherein the configuration for the RIS-RS comprises a resource set configured for measuring a channel between the RIS and the user equipment.

3. The network entity of claim 2, wherein the configuration for the RIS-RS comprises one or more sequences.

4. The network entity of claim 3, wherein at least one of the one or more sequences is a gold sequence or an m-sequence.

5. The network entity of claim 2, wherein:
the configuration for the RIS-RS indicates a plurality of RIS-RS sets, each respective RIS-RS set of the plurality of RIS-RS sets is configured with a respective sequence for each RIS-RS included in the respective RIS-RS set, and
RIS-RSs in different RIS-RS sets of the plurality of RIS-RS sets are configured with different sequences from one another.

6. The network entity of claim 2, wherein:
the configuration indicates one or more time and frequency locations associated with the RIS-RS, and
the one or more time and frequency locations define one or more gap resources between the RIS-RS and other time and frequency locations associated with a data transmission.

7. The network entity of claim 1, wherein the one or more processors are configured to execute the computer-executable instructions and further cause the network entity to:
transmit, to the user equipment, a channel state information reference signal (CSI-RS),
wherein the RIS-RS is not quasi-collocated with the CSI-RS.

8. The network entity of claim 1, wherein the one or more processors are configured to execute the computer-executable instructions and further cause the network entity to:
transmit, to the user equipment, a synchronization signal block (SSB), wherein the RIS-RS is not quasi-collocated with the SSB.

9. The network entity of claim 1, wherein the one or more processors are configured to execute the computer-executable instructions and further cause the network entity to:
transmit, to the user equipment, quasi-collocation (QCL) information comprising an index associated with the RIS-RS.

10. The network entity of claim 9, wherein the index is indicated by a NZP-CSI-RS-ResourceID.

11. The network entity of claim 1, wherein one of the one or more measurements comprises a layer 1 received signal received power (RSRP) measurement.

12. The network entity of claim 1, wherein the one or more processors are configured to execute the computer-executable instructions and further cause the network entity to:
receive, from the user equipment, a first beam report comprising one or more measurements associated with one or more direct beams, wherein the one or more direct beams are transmitted from the network entity to the user equipment; and
receive, from the user equipment, a second beam report comprising one or more measurements associated with one or more indirect beams, wherein the one or more indirect beams are not transmitted by the network entity to the user equipment.

13. The network entity of claim 1, wherein the one or more processors are configured to execute the computer-executable instructions and further cause the network entity to:
receive, from the user equipment, a beam report comprising one or more measurements associated with one or more direct beams and one or more measurements associated with one or more indirect beams, wherein the one or more direct beams are transmitted from the network entity to the user equipment, and
wherein the one or more indirect beams are not transmitted by the network entity to the user equipment.

14. The network entity of claim 1, wherein the one or more processors are configured to execute the computer-executable instructions and further cause the network entity to perform timing refinement based on the one or more measurements associated with the RIS-RS.

15. The network entity of claim 1, wherein the one or more processors are configured to execute the computer-executable instructions and further cause the network entity to:
receive, from the user equipment, a request for transmission of the RIS-RS over a random access channel (RACH),
wherein transmitting, to the user equipment, the RIS-RS is performed over the RACH in response to the request.

16. A user equipment configured for wireless communications, comprising:
a memory comprising computer-executable instructions; and
one or more processors configured to execute the computer-executable instructions and cause the user equipment to:
receive, from a reconfigurable intelligent surface (RIS), a reconfigurable intelligent surface reference signal (RIS-RS) transmitted by a network entity, wherein the RIS-RS is not associated with a physical broadcast channel (PBCH); and
transmit, to the network entity, a channel state information (CSI) report comprising one or more measurements associated with the RIS-RS.

17. The user equipment of claim 16, wherein the one or more processors are configured to execute the computer-executable instructions and further cause the user equipment to:
receive, from the network entity, a configuration for the RIS-RS, wherein the configuration for the RIS-RS comprises a resource set configured for measuring a channel between the RIS and the user equipment.

18. The user equipment of claim 17, wherein the configuration schedules the RIS-RS periodically.

19. The user equipment of claim 17, wherein the configuration schedules the RIS-RS semi-periodically.

20. The user equipment of claim 17, wherein the configuration schedules the RIS-RS aperiodically.

21. The user equipment of claim 17, wherein the configuration comprises a gold sequence.

22. The user equipment of claim 17, wherein:
the configuration indicates one or more RIS-RS sets, and the RIS-RS is associated with one of the one or more RIS-RS sets.

23. The user equipment of claim 22, wherein:
each respective RIS-RS set of the one or more RIS-RS sets is configured with a respective sequence for each RIS-RS included in the respective RIS-RS set, and
RIS-RSs in different RIS-RS sets of the one or more RIS-RS sets are configured with different sequences from one another.

24. The user equipment of claim 17, wherein:
the configuration indicates one or more time and frequency locations associated with the RIS-RS, and
the one or more time and frequency locations define one or more gap resources between the RIS-RS and any other time and frequency locations associated with a data transmission.

25. The user equipment of claim 16, wherein the one or more processors are configured to execute the computer-executable instructions and further cause the user equipment to:
receive, from the network entity, a channel state information reference signal (CSI-RS),
wherein the RIS-RS is not quasi-collocated with the CSI-RS.

26. The user equipment of claim 25, wherein the one or more processors are configured to execute the computer-executable instructions and further cause the user equipment to:
receive, from the network entity, a synchronization signal block (SSB), wherein the RIS-RS is not quasi-collocated with the SSB.

27. The user equipment of claim 16, wherein the one or more processors are configured to execute the computer-executable instructions and further cause the user equipment to select a new receive beam based on the one or more measurements associated with the RIS-RS.

28. The user equipment of claim 16, wherein the one or more processors are configured to execute the computer-executable instructions and further cause the user equipment to determine a beam failure based on the RIS-RS.

29. A method of wireless communications by a network entity, comprising:
transmitting, to a reconfigurable intelligent surface (RIS), a reconfigurable intelligent surface reference signal (RIS-RS) configured for a user equipment, wherein the RIS-RS is not associated with a physical broadcast channel (PBCH); and
receiving, from the user equipment, a channel state information (CSI) report comprising one or more measurements associated with the RIS-RS.

30. A method of wireless communications by a user equipment, comprising:
receiving, from a reconfigurable intelligent surface (RIS), a reconfigurable intelligent surface reference signal (RIS-RS) transmitted by a network entity, wherein the RIS-RS is not associated with a physical broadcast channel (PBCH); and
transmitting, to the network entity, a channel state information (CSI) report comprising one or more measurements associated with the RIS-RS.
